(19) United States
(12) Patent Application Publication
(10) Pub. No.: US 2001/0046401 A1
(43) Pub. Date: Nov. 29, 2001

(54) Thermal print ribbon compensation

(76) Inventors: Brent D. Lien, Minneapolis, MN (US); Daniel P. Gage, Zimmerman, MN (US)

Correspondence Address: Brian D. Kaul, WESTMAN, CHAMPLIN & KELLY, P.A., International Centre, Suite 1600, 900 Second Avenue South, Minneapolis, MN, 55402-3319, US

(21) Appl. No.: 09/792,779

(22) Filed: Feb. 23, 2001

Related U.S. Application Data
(60) Provisional application No. 60/187,718, filed on Mar. 8, 2000.

(51) Int. Cl. B41J 31/09; B41J 33/00; B41J 33/02; B41J 33/06; B41J 33/08; B41J 33/10; B41J 33/12

(52) U.S. Cl. 400/240; 400/237; 400/240.4

(57) ABSTRACT

A method for improving print quality of an identification card printing system is provided. In the method, heat is applied to a primary image portion of a thermal print ribbon corresponding to a primary image. Heat is also applied to a remainder portion of the thermal print ribbon defined as a portion of the thermal print ribbon that extends beyond the primary image portion to at least one lengthwise edge of the thermal print ribbon. In this manner, the thermal print ribbon is substantially uniformly heated across its width thereby reducing uneven stretching of the thermal print ribbon and improving the quality of the primary image that is ultimately transferred to a substrate. Also provided is an identification card printing system that is adapted to implement the above-described method.

### CROSS REFERENCE TO RELATED APPLICATION

This application claims the benefit of U.S. provisional patent application Serial No. 60/187,718, filed Mar. 8, 2000, entitled “METHOD OF COMPENSATING FOR RIBBON STRETCH” the content of which is hereby incorporated by reference in its entirety.

### FIELD OF THE INVENTION

The present invention relates to printing systems which use a thermal transfer ribbon that is heated by a thermal printhead to cause printing material to pass from the ribbon to a substrate to cause an image to be printed thereon. More particularly, the present invention relates to a method of compensating a thermal transfer ribbon to reduce uneven stretching of the ribbon during the printing process and thereby reduce defects in the printed image.

### BACKGROUND OF THE INVENTION

Identification cards are widely used to carry information typically relating to the card holder. Identification card printing systems are used to form identification cards by printing an image, which can contain textual and graphical information, on a card-like substrate, such as a plastic card.

Many identification card printing systems are thermal based printing systems, which print images on substrates using a thermal printhead and a thermal print ribbon that is held taut between the printhead and the substrate. The printhead is used to heat the thermal print ribbon and cause print material (black or colored) to transfer to the substrate and form the desired image.

In some configurations, the substrate to which the print material from the thermal print ribbon is transferred is the card-like substrate that forms the identification card. Alternatively, the substrate can take the form of an intermediate transfer film on which the image is reversely printed and subsequently transferred to a card to form the identification card.

It is important for identification (card printing systems to be able to print high quality images having few defects. This is due, in part, to the fact that the printed identification cards are often used for security purposes where it is necessary that, for example, photos be printed with sufficient quality such that the card holder can be matched to the photo printed on the card. In addition, security marks are often printed cards to ensure their authenticity. These security marks typically include a high amount of detail, which must be rendered accurately. Consequently, it is desirable to avoid or at least reduce the potential for printing defects in identification card printing systems.

One cause of printing defects in thermal based identification card printing systems is the uneven heating of the thermal transfer ribbon by the printhead. This typically occurs when the image that is to be printed has a width that is less than the width of the thermal transfer ribbon. In that case, only the portion of the thermal transfer ribbon that corresponds to the image is heated by the thermal printhead. The heated portion of the thermal print ribbon stretches due to the heat and the tension in the ribbon while the unheated portions of the ribbon resist stretching. This uneven stretching of the ribbon can cause wrinkles to form in the ribbon that significantly affect the accuracy and print quality of the printed image on the substrate.

### SUMMARY OF THE INVENTION

The present invention is directed to a method for use with an identification card printing system for improving print quality of a primary image by reducing uneven stretching of the thermal print ribbon. In the method, heat is applied to a primary image portion of the thermal print ribbon corresponding to a primary image and also to a remainder portion of the thermal print ribbon. The remainder portion of the thermal print ribbon is defined as a portion of the thermal print ribbon that extends beyond the primary image portion to at least one lengthwise edge of the thermal print ribbon. In this manner, the thermal print ribbon is substantially uniformly heated across its width thereby reducing uneven stretching of the thermal print ribbon and improving the quality of the primary image that is ultimately printed on the substrate.

In addition, the present invention is directed toward an identification card printing system that is adapted to implement the above method to reduce printing defects caused by uneven stretching of a thermal print ribbon.

### BRIEF DESCRIPTION OF THE DRAWINGS

FIG. 1 is a block diagram of an identification card printing system in accordance with embodiments of the present invention.

FIG. 2 is a diagrammatic end view of the thermal printhead shown in FIG. 1 in accordance with one embodiment of the invention.

FIGS. 3 and 4 are schematic representations of identification card printing systems in accordance with various embodiments of the invention.

FIGS. 5A and 5B are plan views of thermal print ribbons depicting heated and unheated portions of the thermal print ribbons during the printing of a primary image in accordance with methods of the prior art.

FIGS. 6 and 7 are plan views of compensated thermal print ribbons in accordance with various embodiments of the invention.

FIG. 8 is a flowchart illustrating a method of reducing uneven stretching of a thermal print ribbon in accordance with an embodiment of the invention.

### DETAILED DESCRIPTION OF THE PREFERRED EMBODIMENTS

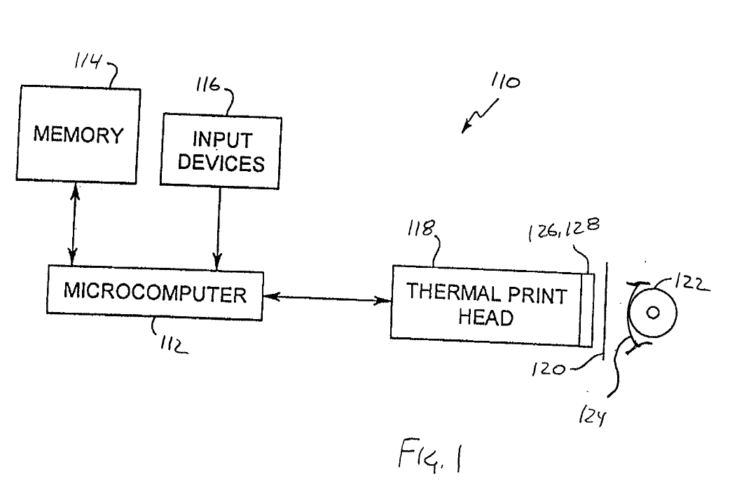

FIG. 1 illustrates an example of an identification card printing system, generally designated as 110, with which embodiments of the present invention can be used. Identification card printing system 110 generally includes microcomputer 112, memory 114, input devices 116, thermal printhead 118, thermal print ribbon 120, and substrate feeder mechanism 122. Identification card printing system 110 is adapted to print images on substrate 124. The images typically include textual and graphical information that is used for identification and security purposes. As will be discussed in greater detail below, substrate 124 can be a card or an intermediate transfer film, from which the printed image is transferred onto a card.

Thermal print ribbon 120 is a thermally sensitive ribbon of a type well known in the art, such as, for example, a dye sublimation ribbon or other type of thermally sensitive print ribbon. Thermal print ribbon 120 is positioned between thermal printhead 118 and substrate 124 and contains a thermally sensitive print material that is transferred to substrate 124 when heated by thermal printhead 118. The amount of print material transferred to substrate 124 is dependent upon the heat applied by thermal printhead 118.

Microcomputer 112 is preferably a microprocessor-based device of a type well known in the art. However, in other embodiments, microcomputer 112 can be any analog or digital circuitry capable of implementing the method of the present invention. Memory 114 is coupled to microcomputer 112 and can be any of a large variety of conventional data storage devices for temporarily and/or permanently storing data for use by microcomputer 112. In other embodiments, memory 114 can be integrated within microcomputer 112 instead of being a separate component. Microcomputer 112 can be adapted to run a software application that produces image files which it can process. In preferred embodiments, a separate personal computer (not shown) is utilized to process data according to the methods of the present invention. The data or image file is then transferred to microcomputer 112 for processing of the data and actual control of printhead 118.

Input devices 116 are coupled to microcomputer 112 and can be of any of a wide variety of devices adapted for providing information and/or control data to microcomputer 112. For instance, input devices 116 can include, for example, a keyboard, a keypad entry device, a sensor, and other types of input devices. Additionally, input devices 116 can include a separate computing system which provides image files to microcomputer 112 for processing, as mentioned above.

Printer driver software, stored in memory 114, is adapted to process an image file from the software application. Alternatively, the printer driver software could be stored in a personal computer that is operating as an input device 116 such that data from the printer driver software can be communicated to microcomputer 112. The image file contains data that represents a primary image which is to be printed by identification card printing system 110. The printer driver is used to process the image file and control printhead 118 to print the image. Microcomputer 112 controls thermal printhead 118 to print multiple print lines which together form the desired image in accordance with data or instructions from the printer driver.

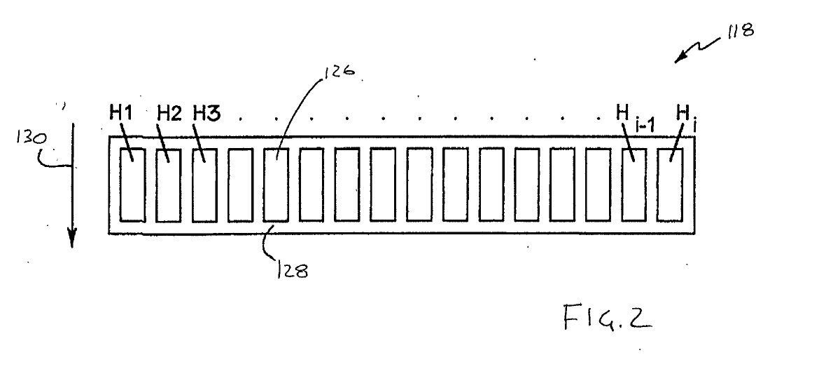

Thermal printhead 118 is of the type that is well known in the art having a column of resistive elements 126 on end 128, as shown in FIG. 2. The column of resistive elements 126 are designated as H₁ through Hᵢ, where i is equal to the number of resistive elements 126 on end 128, and therefore, is also equal to the number of pixels per print line that printhead 118 is capable of printing. Thermal print ribbon 120 is generally moved in the direction indicated by arrow 130 to allow printhead 118 to heat a portion of thermal print ribbon 120 corresponding to the image that is to be transferred to substrate 124.

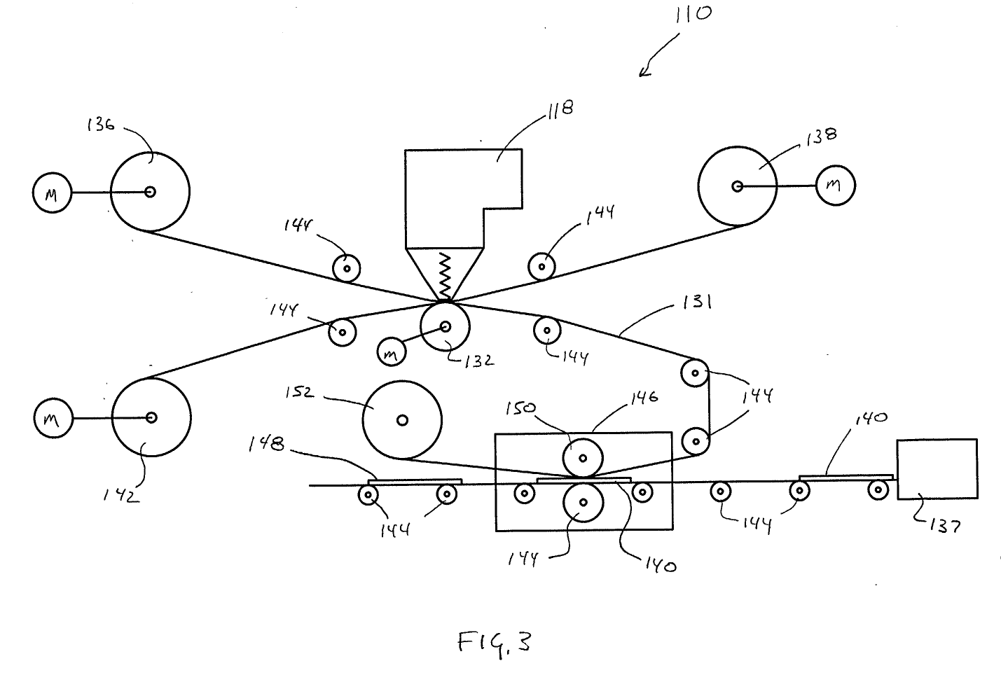

Referring now to FIG. 3, an identification card printing system 110 is shown in accordance within one embodiment of the invention. Here, substrate 124, to which thermal print ribbon 120 transfers print material in accordance with the heat applied by thermal printhead 118, is an intermediate transfer film 131. Once the image is printed to intermediate transfer film 131, it is transferred to a card 140 to form the desired printed identification card. This process requires that the image printed on intermediate transfer film 131 be a reverse of the image that is desired on card 140.

In this embodiment, thermal print ribbon 120 moves from a supply role 136 underneath the column of resistive heating elements 126 of thermal printhead 118 and to a take-uproll 138. Intermediate transfer film 131 is moved from a supply role 142 between thermal print ribbon 120 and platen 132. As thermal printhead 118 heats thermal print ribbon 120, print material is transferred from thermal print ribbon 120 to intermediate transfer film 131 to form a print line, several of which form the desired image. The thermal print ribbon 120 and intermediate transfer film 131 are shifted slightly toward respective takeup rolls 138 and 152 to allow printhead 118 to heat thermal print ribbon 120 and cause print material to transfer to intermediate transfer film 131 and form the next print line of the image. This step is repeated until all of the print lines that form the image are printed on intermediate transfer film 124A.

Intermediate transfer film 131 is moved through identification card printing system 110 using a suitable substrate feeder mechanism 122 that can include such components as platen 132 and guide rollers 144, which guide the intermediate transfer film 131 to an image transfer module 146. Image transfer module 146 receives cards 140 from a card supply 147 using an appropriate card feeder mechanism which can include guide rollers 144. Image transfer module 146 includes heated roller 150 which is used to heat intermediate transfer film 131 and cause the print material forming the image to be transferred to card 140. After the image is transferred to card 140, intermediate transfer film 131 is taken up on take-up roller 152 in a conventional manner and the printed card 148 is then discharged.

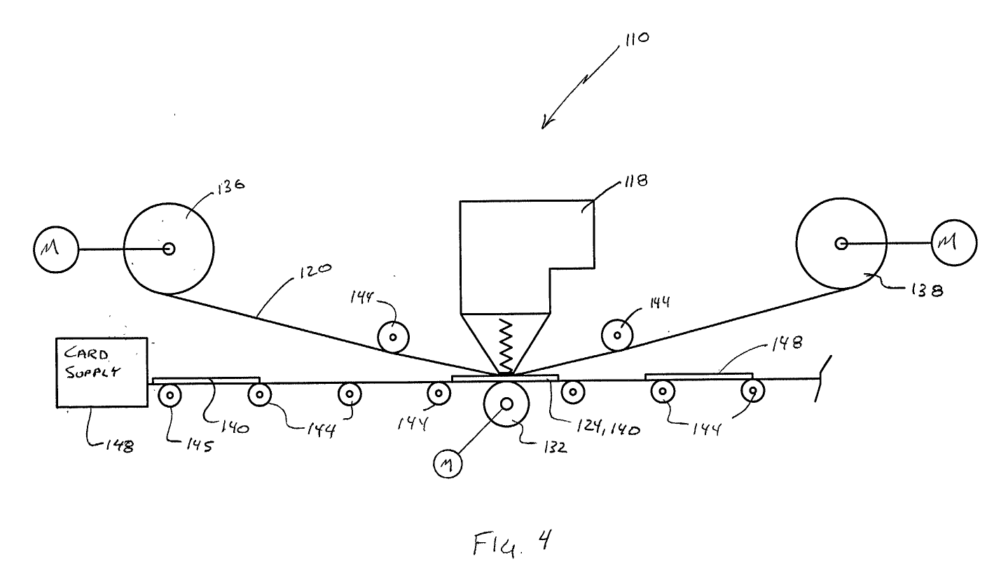

FIG. 4 shows another embodiment of identification card printing system 110 in which substrate 124 is a card 140. As with the embodiment of identification card printing system 110 depicted in FIG. 3, thermal print ribbon 120 is fed from a supply roll 136 underneath thermal printhead 118 and received by take-up roll 138. Thermal print ribbon 120 is guided by guide rollers 144 or other suitable components. Card supply 147 provides a supply of cards 140 along a printing path using suitable substrate feeder mechanisms, such as guide rollers 144 to guide a card 140 between thermal print ribbon 120 and platen 132 where an image can be printed onto a surface of card 140. The printed card 148 can then be discharged.

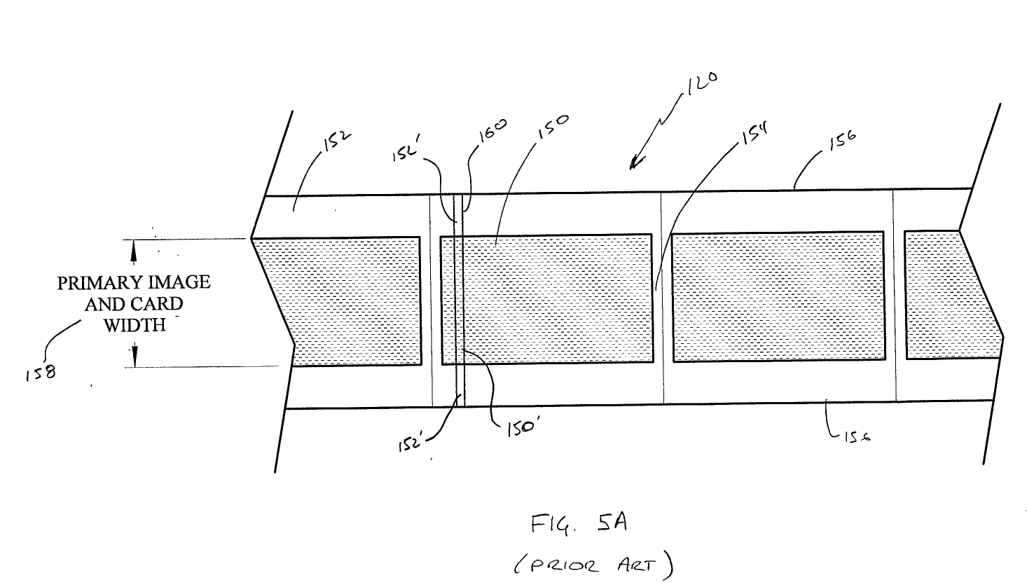

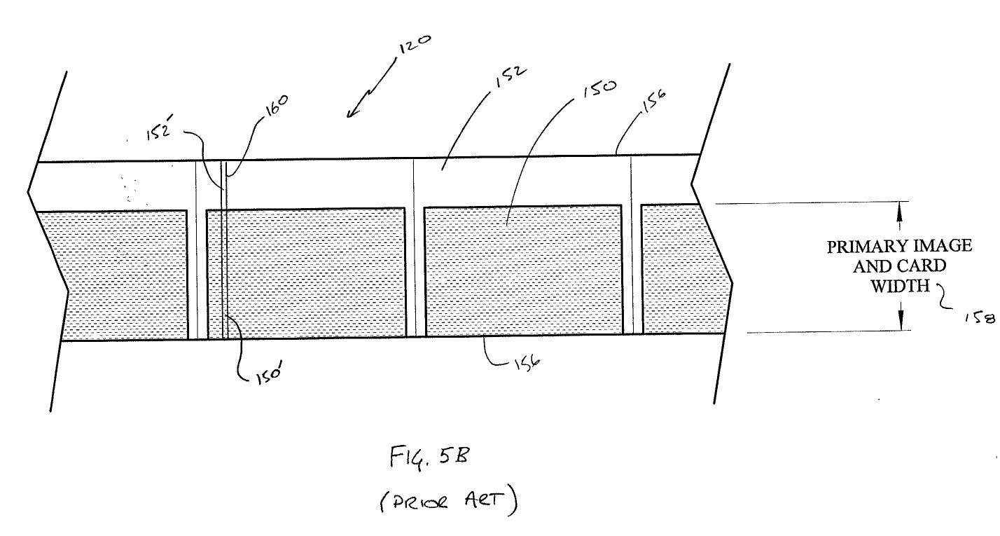

FIGS. 5A and 5B show thermal print ribbons 120, which have been heated by a thermal printhead 118 in accordance with thermal printing processes of the prior art. In general, these printing processes cause thermal printhead 118 to heat a primary image portion 150 of thermal print ribbon 120 to cause print material within primary image portion 150 to transfer to a substrate 124 (FIG. 1) such as intermediate transfer ribbon 131 (FIG. 3) or card 140 (FIG. 4). The primary image portion 150 thus corresponds to the primary image that is to be printed on substrate 124. A remainder portion 152 generally surrounds primary image portion 150 of thermal print ribbon 120 and, in the thermal printing processes of the prior art, is a substantially non-heated portion of thermal print ribbon 120.

The primary image portion 150 can be placed in a center portion 154 of thermal print ribbon 120, as shown in FIG. 5A, or along a lengthwise edge 156 of thermal print ribbon 120, as shown in FIG. 5B. In addition, primary image portion 150 has a width 158, which is less than a width of thermal print ribbon 120 defined as the distance between lengthwise edges 156. As a result, remainder portion 152 is located beyond primary image portion 150 and extends to either one (FIG. 5B) or two (FIG. 5A) lengthwise edges 156. Furthermore, a print line 160 (not shown to scale) formed on thermal print ribbon 120 by printhead 118 includes a primary image portion 150′ and a remainder portion 152′.

Identification card printing system 110 maintains tension in thermal print ribbon 120 during the printing process. The tension in thermal print ribbon 120 causes thermal transfer ribbon 120 to stretch in the heated or primary image portions 150 while remaining substantially unstretched in the remainder portions 152. This uneven stretching of thermal print ribbon 120 leads to wrinkling of thermal print ribbon 120, which produces defects in the primary image that is transferred to substrate 124. The method of present invention reduces the likelihood of the formation of wrinkles or other defects in thermal print ribbon 120 during the printing of a primary image on a substrate 124, by more evenly heating thermal print ribbon 120 across its width.

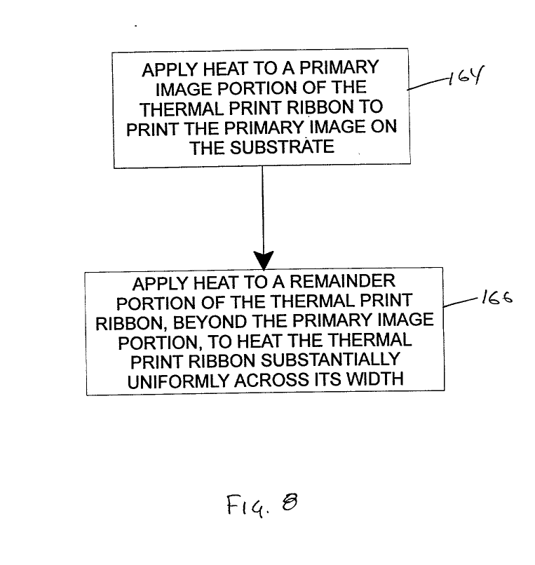

The method of the present invention is illustrated in the flowchart of FIG. 8. At step 164, heat is applied to primary image portion 150 (or primary image portion 150′ of print line 160) to cause print material corresponding to a primary image to transfer from thermal print ribbon 120 to substrate 124. At step 166, heat is applied to remainder portion 152 (or remainder portion 152′ of print line 160), such that thermal print ribbon is heated substantially across its entire width.

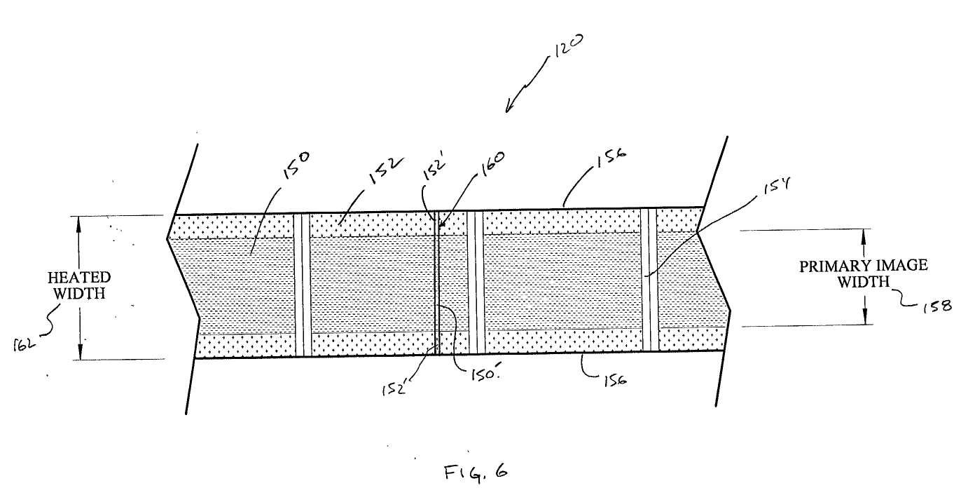

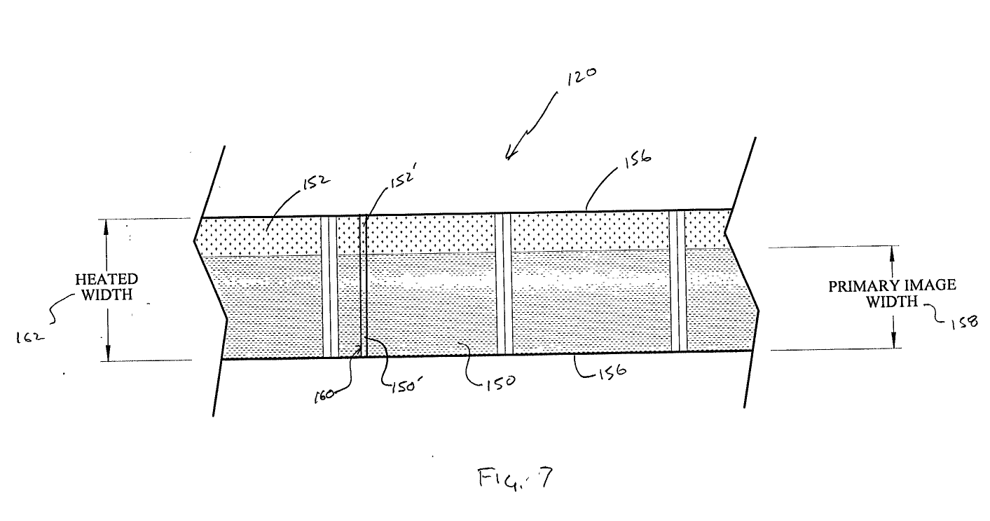

This is illustrated in the simplified diagrams of FIGS. 6 and 7, which show the heated primary image portion 150 as found in the prior art, along with heated remainder portions 152. Here, the width 162 of thermal print ribbon 120 that is heated covers substantially the entire width of thermal print ribbon 120. It is preferred that the remainder portion 152 combine with the primary image portion 150 such that the entire width of thermal print remainder 120 extending between lengthwise edges 156 is heated. Accordingly, in the thermal print ribbon 120 depicted in FIG. 7 where primary image portion 150 is located in center portion 154 of thermal print ribbon 120, heat is applied to remainder portion 152 which extends beyond primary image portion 150 to at least proximate lengthwise edges 156. In the alternative arrangement shown in FIG. 8, primary image portion 150 abuts one of the lengthwise edges 156 such that remainder portion 152 extends beyond primary image portion to at least proximate the other lengthwise edge 156. A print line 160 is formed of primary image portion 150′ and heated remainder portion 152′, as shown in FIGS. 7 and 8.

The amount of heat applied to remainder portion 152 is preferably based upon the heat applied to primary image portion 150. In one embodiment, the heat applied to remainder portion 152 is an average of the heat applied to primary image portion 150. In another embodiment, the heat applied to remainder portion 152 is a percentage of the total or average heat applied to the primary image portion 150.

The amount of heat applied to primary image portion 150 can be determined based upon pixel level data for each of the resistive elements 126 that are used to form primary image portion 150′ of print line 160. The pixel level data can be provided in the form of a data byte for each pixel or resistive element 126. Each data byte can, for example, correspond to a shade level for the pixel. Thus the data byte could represent 256 different shade levels. Since the shade level for the pixels are related to the heat applied to thermal print ribbon 120, the pixel level data can be used to determine the amount of heat that is applied by resistive elements 126 of thermal printhead 118 to primary image portion 150′ of a given print line 160. Thus, an average heat applied to each pixel within primary image portion 150′ can be determined by calculating the average shade level of the pixels (resistive elements 126) that are within, or used to print, primary image portion 150′.

Remainder portion 152 can also be heated to a threshold temperature of the thermal print ribbon 120, above which print material begins to transfer to substrate 124. In yet another embodiment, remainder portion 152 can be heated to a level relating to the shade level of the pixel of primary image portion 150 that is adjacent to the remainder portion 152.

Although the present invention has been described with reference to preferred embodiments, workers skilled in the art will recognize that changes may be made in form and detail without departing from the spirit and scope of the invention.

Although the present invention has been described with reference to preferred embodiments, workers skilled in the art will recognize that changes may be made in form and detail without departing from the spirit and scope of the invention.

What is claimed is:

1. A method for improving print quality of a primary image produced by an identification card printing system having a printhead that is adapted to heat a thermal print ribbon, having lengthwise edges and a width, to cause print material to transfer from the thermal print ribbon to a substrate, the method comprising steps of:
(a) applying heat to a primary image portion of the thermal print ribbon corresponding to the primary image; and
(b) applying heat to a remainder portion of the thermal print ribbon defined as a portion of the thermal print ribbon beyond the primary image portion and extending proximate to at least one of the lengthwise edges.

2. The method of claim 1, wherein the heat applied to the remainder portion of the thermal print ribbon in the applying step (b) is based upon the heat applied to the primary image portion of the thermal print ribbon in the applying step (a).

3. The method of claim 2, wherein the heat applied to the remainder portion in the applying step (b) is selected from a group consisting of an average of the heat applied to the primary image portion, a percentage of the heat applied to the primary image portion, and a percentage of the average heat applied to the primary image portion.

4. The method of claim 1, wherein the heat applied to the remainder portion causes the remainder portion to reach a threshold temperature, beyond which print material becomes transferable to the substrate.

5. The method of claim 1, further comprising a step of (c) transferring print material of the thermal print ribbon corresponding to the primary image portion to the substrate.

6. The method of claim 5, wherein the substrate is a card.

7. The method of claim 1, further comprising a step of (c) transferring print material of the thermal print ribbon corresponding to the primary and remainder image portions to the substrate.

8. The method of claim 7, wherein the substrate is an intermediate transfer film.

9. The method of claim 1, wherein the remainder portion extends to at least one of the lengthwise edges of the thermal print ribbon.

10. The method of claim 1, wherein:
the primary image portion is located in a central portion of the thermal print ribbon; and
the remainder portion extends beyond the primary image portion to substantially proximate the lengthwise edges of the thermal print ribbon.

11. The method of claim 10, wherein the remainder portion extends from beyond the primary image portion to the lengthwise edges of the thermal print ribbon.

12. A method for improving print quality of a primary image produced by an identification card printing system having a printhead that is adapted to heat a thermal print ribbon, having lengthwise edges and a width, to cause print material to transfer from the thermal print ribbon to a substrate, the method comprising steps of:
(a) applying heat to the thermal print ribbon at a primary image portion of a print line; and
(b) applying heat to the thermal print ribbon at a remainder portion of the print line defined as a portion of the print line beyond the primary image portion and extending substantially proximate to at least one of the lengthwise edges of the thermal print ribbon.

13. The method of claim 12, wherein the remainder portion extends to at least one of the lengthwise edges of the thermal print ribbon.

14. The method of claim 12, wherein:
the primary image portion is located in a central portion of the thermal print ribbon; and
the remainder portion extends beyond the primary image portion to substantially proximate the lengthwise edges of the thermal print ribbon.

15. The method of claim 14, wherein the remainder portion extends from beyond the primary image portion to the lengthwise edges of the thermal print ribbon.

16. The method of claim 12, wherein the heat applied to the remainder portion of the thermal print ribbon in the applying step (b) is based upon the heat applied to the primary image portion of the thermal print ribbon in the applying step (a).

17. The method of claim 16, wherein the heat applied to the remainder portion in the applying step (b) is selected from a group consisting of an average of the heat applied to the primary image portion, a percentage of the heat applied to the primary image portion, and a percentage of the average heat applied to the primary image portion.

18. The method of claim 12, wherein the heat applied to the remainder portion causes the remainder portion to reach a threshold temperature, beyond which print material becomes transferable to the substrate.

19. An identification card printing system comprising:
a substrate feeder mechanism adapted to transport a substrate along a printing path;
a thermal printhead in line with the printing path and having a plurality of resistive heaters arranged in a line;
a thermal print ribbon positioned between the thermal print head and the substrate and in line with the printing path, and having a width that is greater than a width of the substrate;
a microcomputer;
a memory; and
a printer driver stored in the memory and including instructions executable by the microcomputer to perform steps of:
(a) applying heat to a primary image portion of the thermal print ribbon with the thermal printhead corresponding to the primary image; and
(b) applying heat to a remainder portion of the thermal print ribbon with the thermal printhead, the remainder portion defined as a portion of the thermal print ribbon beyond the primary image portion and extending proximate to at least one of the lengthwise edges.

20. The identification card printing system of claim 19, wherein the heat applied to the remainder portion of the thermal print ribbon in the applying step (b) is based upon the heat applied to the primary image portion of the thermal print ribbon in the applying step (a).
